(19) United States
(12) Patent Application Publication
(10) Pub. No.: US 2025/0042282 A1
(43) Pub. Date: Feb. 6, 2025

(54) CHARGING STATION WITH AT LEAST ONE PHOTOVOLTAIC MODULE

(71) Applicant: ads-tec Energy GmbH, Nürtingen (DE)

(72) Inventors: Thomas SPEIDEL, Markgröningen (DE); Roman MOLCHANOV, Neckartenzlingen (DE)

(21) Appl. No.: 18/789,758

(22) Filed: Jul. 31, 2024

(30) Foreign Application Priority Data
Aug. 1, 2023 (DE) 102023120442.4

(51) Int. Cl. B60L 53/51; H02S 20/23; H02S 20/32; H02S 40/38

(52) U.S. Cl. CPC B60L 53/51; H02S 20/23; H02S 20/32; H02S 40/38

(57) ABSTRACT

The invention relates to a charging station including a housing, an electrical energy store, and at least one photovoltaic module, wherein
the at least one photovoltaic module is mechanically connected to the housing, and wherein
the at least one photovoltaic module is electrically connected to the electrical energy store, such that the electrical energy store may be charged with electrical power generated by the at least one photovoltaic module.

The invention relates to a charging station, in particular for electric vehicles, having at least one photovoltaic module.

It is known that a charging station, in particular for electric vehicles, has a daily standby power consumption of 12 kW to 24 KW, without taking into account any charging operations. This standby power has to be drawn either from a public power grid or an integrated electrical energy store—if the charging station includes such an electrical energy store and is optionally not connected to the public power grid. Disadvantageously, this results in additional costs for operating the charging station. Furthermore, the electrical energy store—in particular for charging stations that are not connected to the public power grid—has to be replaced and/or charged more often, which results in additional costs. In addition, the daily standby power consumption provided by electrical power generated by conventional means results in a negative carbon footprint of the charging pile.

Therefore, the underlying object of the invention is to provide a charging station including at least one photovoltaic module, where the aforementioned disadvantages are at least reduced, and preferably do not occur.

The object is achieved by providing the present technical teachings, in particular the teachings of the independent claims as well as the preferred embodiments disclosed in the dependent claims and the description.

The object is specifically achieved by providing a charging station, in particular for electric vehicles, in particular for electric cars or trucks, including a housing, an electric energy store, and at least one photovoltaic module. The at least one photovoltaic module is mechanically connected to the housing. In addition, the at least one photovoltaic module is electrically connected to the electrical energy store, such that the electrical energy store may be charged with electrical power generated by the at least one photovoltaic module. Advantageously, this improves the carbon footprint of the charging pile, because charging of the electrical energy store with conventionally generated electrical power is reduced. Furthermore and advantageously, the standby power consumption may be covered at least in part, preferably completely, by the electrical power generated by the at least one photovoltaic module, thereby further improving the carbon footprint.

In electrical engineering, the term charging station refers to any device or electrical installation, in particular any stationary or mobile device or electrical installation, that is to supply energy to mobile, battery-powered devices, machines, or motor vehicles by simply positioning or plugging them in, without necessarily having to remove the energy store—for example the traction battery of an electric car. Charging stations for electric cars are sometimes also referred to as “electric filling stations” and may include multiple charging points. In particular, fast-charging DC systems (high performance charging systems or high-power charging systems, HPC systems) such as the so-called combined charging system (CCS) that is widespread in Europe. With generic DC charging, direct current from the charging station is fed directly into the vehicle battery and is supplied for this purpose by a high-power rectifier, preferably the charging station, from the power grid or by large buffer batteries, for example at solar charging stations. Within the vehicle, a battery management system is disposed which directly or indirectly communicates with the charging station, in order to adjust the current and the voltage or terminate the operation upon reaching a predetermined capacity limit. Power electronics are typically located in the charging station. Since the DC ports of the charging station are connected directly—without being routed through an AC/DC converter of the vehicle—to corresponding ports of the traction battery, high charging currents may be transmitted with low loss, allowing for short charging times.

In an embodiment, the charging station is configured as a charging pile. In particular, the charging station includes at least one charging point, in particular exactly one charging point or exactly two charging points.

In particular, the charging station is configured as a fast-charging station. In an embodiment, the charging station is configured as a battery-backed charging station, in particular as a battery-backed fast-charging station.

In particular, the at least one photovoltaic module generates the electrical power as direct current. Alternatively, the at least one photovoltaic module generates the electrical power—in particular in combination with an inverter—as alternating current.

In particular, the charging station is electrically self-contained and therefore in particular not connected to the public power grid—specifically herein referred to as a stand-alone charging station. Alternatively, the charging station is electrically connected to a public power grid—specifically herein referred to as a grid charging station.

In an embodiment, the charging station is configured to be connected to a power grid, in particular a public power grid, in particular to draw electrical power from the power grid or supply power to the power grid—selectively or depending on an operating state of the charging station. Preferably, the charging station is configured to draw electrical power from the power grid in a receiving state and to supply electrical power to the power grid in a supplying state. The power drawn from the power grid may be used to charge an electrical device, in particular, an electric vehicle, alternatively or additionally, it may be used to charge the electrical energy store. The electrical power supplied to the power grid may originate from the photovoltaic module, alternatively or additionally, the electrical power supplied to the power grid may be withdrawn from the electrical energy store. Preferably, the supply of electrical power provided by the photovoltaic module to the power grid may be blocked, such that the corresponding energy is fully charged into the electrical energy store.

In particular, the charging station includes a rectifier. The rectifier is configured to convert an alternating current of the public power grid into a direct current for charging the electrical energy store. Alternatively or additionally, the rectifier is configured to convert an alternating current of the at least one photovoltaic module into a direct current for charging the electrical energy store. In particular, the charging station may include a plurality of rectifiers, where a first rectifier is configured to convert an alternating current of the at least one photovoltaic module into a direct current for charging the electrical energy store, and a second rectifier is configured to convert an alternating current of the public power grid into a direct current for charging the electrical energy store.

In an embodiment, the at least one photovoltaic module generates the electrical power as direct current and is electrically connected to the electrical energy store in a direct fashion. Optionally, the photovoltaic module is also connected to an inverter that is able to convert direct current into alternating current to supply electrical power to the power grid on demand. Advantageously, the electrical energy store may be charged in a loss-less manner by the direct current generated by the photovoltaic module, while it is still possible to also supply electrical power to the power grid as alternating current.

In particular, one photovoltaic module of the at least one photovoltaic module has a width of 150 cm to 200 cm and a length of 50 cm to 100 cm. Thus, one photovoltaic module of the at least one photovoltaic module has an area of 0.75 m² to 2 m².

In an embodiment, the charging station includes at least one operating device, selected from a group consisting of a display device, an air conditioning device, a control device, and any combination of at least two of the aforementioned operating devices. The at least one operating device is electrically connected to the at least one photovoltaic module. This allows operating the at least one operating device directly with the electrical power generated by the at least one photovoltaic module. In addition and in particular, the at least one operating device is electrically connected to the electrical energy store. In particular, the charging station has a standby power consumption—in particular, power consumption without supplying electrical energy for charging a motor vehicle—of 500 Wh to 1000 Wh, such that 12 kW to 24 KW are drawn daily from the electrical power store for operating the charging station. Advantageously, thereby the electrical energy of the electrical energy store is only used in part—and in particular only when the at least one photovoltaic module does not generate electrical power—for standby operation of the charging station and is available for any potential charging operations.

In particular, the electrical energy store has a capacity of 280 kWh. Thus, the electrical energy store of a charging station without photovoltaic module will be depleted after about 10 to 23 days with a daily standby power consumption of 12 kW to 24 kW and without charging operations. Advantageously, the at least one photovoltaic module increases the time to depletion of the electrical energy store with this standby power consumption and without charging operations.

In particular, a photovoltaic module of the at least one photovoltaic module generates at least 300 Wₚ of power. In the context of the present technical teachings, this means that the photovoltaic module of the at least one photovoltaic module has a power rating in accordance with standard test conditions—at a photovoltaic module temperature of 25° C., an irradiance of 1000 W/m² and a solar spectrum according to AM=1.5—of at least 300 Wh. In particular, the photovoltaic module generates 200 kW to 300 kW of electrical power per year, such that the electrical energy store can be charged once a year by means of the one photovoltaic module. In an embodiment, where the charging station is electrically connected to a public power grid, this advantageously leads to cost savings in the order of €60 to €90 per year—at a cost of €0.30 per kWh from the public power grid. In an embodiment, where the charging station is electrically self-contained, a single charging process of the electrical energy store—including costs for personnel and logistics—costs around €400, such that with a single photovoltaic module, costs in the order of €400 may be saved. Advantageously, the electrical power generated per year, and thus the number of possible charging processes of the electrical energy store by means of the photovoltaic modules and the cost savings multiply with the number of photovoltaic modules.

According to a further development of the invention, the charging station is additionally provided with a regulating module. The regulating module is electrically arranged between the at least one photovoltaic module and the electrical energy store. Further, the regulating module is configured to supply the electrical power generated by the at least one photovoltaic module exclusively to the electrical energy store. Advantageously, this ensures that electrical power generated by the at least one photovoltaic module is used for the charging station's own demands.

In an embodiment, the charging station is electrically connectable to a public power grid, optionally connected, and optionally, the at least one photovoltaic module generates the electrical power—in particular in combination with an inverter—as alternating current. Additionally, the public power grid and the at least one photovoltaic module are electrically connected to the regulating module. Thereby, in particular, the regulating module is additionally configured to block the supply of the electrical power generated by the at least one photovoltaic module to the public power grid. This ensures advantageously that the charging station generates electrical power only for self-consumption and no supply takes place.

In an embodiment, the at least one photovoltaic module is connected to the housing via a first attachment device and/or a second attachment device. In particular, the first attachment device is configured as a quick-fit fastener. Alternatively or additionally, the second attachment device is configured as a quick-fit fastener.

According to a further development of the invention, the at least one photovoltaic module is connected to the housing by means of a support device. Advantageously, the support device allows orienting and/or arranging the at least one photovoltaic module independently of the orientation of the charging station housing.

In particular, with installation of the charging station as intended, the support device is connected to the housing in a substantially vertical, in particular vertical manner. In particular, thereby the axial direction of the support device is oriented in a substantially vertical, in particular vertical manner. Alternatively, with installation of the charging station as intended, the support device is connected to the housing in a substantially horizontal, in particular horizontal manner.

In an embodiment, the support device, in particular an axial direction of the support device, is oriented at least sectionally, in particular completely, in a substantially vertical, in particular vertical manner. Alternatively or additionally, the support device, in particular an axial direction of the support device, is oriented at least sectionally, in particular completely, in a substantially horizontal, in particular horizontal manner. Alternatively or additionally, the support device is L-shaped, where in particular, with installation of the charging station as intended, a first portion of the support device is oriented in a substantially vertical, in particular vertical manner, and a second portion of the support device is oriented in a substantially horizontal, in particular horizontal manner.

In particular, the support device is embodied as a tube, in particular as a steel tube. Alternatively or additionally, the support device includes a fiber composite or is composed of a fiber composite.

In an embodiment, the support device is connected to the housing via the first attachment device. Alternatively or additionally, the at least one photovoltaic module is connected to the support device via the second attachment device.

In an embodiment, both the support device and the first attachment device are embodied as tubes. In an arrangement of the support device on the housing, the support device encloses the first attachment device—in particular, the tube of the first attachment device is disposed within the tube of the support device. Alternatively, the first attachment device encloses the support device at the housing—in particular, the tube of the support device is disposed within the tube of the first attachment device. Advantageously, the nested arrangement of the tubes reduces a moment of tilt of the support device, in particular relative to the housing.

A further development of the invention provides that the support device is pivotably connected to the housing via the first attachment device. This allows rotating and advantageously orienting the support device and thereby the at least one photovoltaic module located on the support device relative to the housing.

In particular, the first attachment device has a first pivot joint. Alternatively or additionally, the first attachment device includes a first actuator. The first actuator is specifically configured to rotate the support device relative to the housing. In particular, the first actuator is controllable via wire or wirelessly, such that an operator of the charging station is able to easily initiate a rotation of the support device relative to the housing.

In particular, the first attachment device is configured to rotate the support device about the axial direction of the support device.

A further development of the invention provides that the at least one photovoltaic module is pivotably connected to the support device via the second attachment device. This allows rotating and advantageously orienting the at least one photovoltaic module located on the support device relative to the support device.

In particular, the second attachment device has a second pivot joint. Alternatively or additionally, the second attachment device includes a second actuator. The second actuator is specifically configured to rotate the at least one photovoltaic module relative to the support device. In particular, the second actuator is controllable via wire or wirelessly, such that the operator of the charging station is able to easily initiate a rotation of the at least one photovoltaic module relative to the support device.

In particular, the second attachment device is configured to rotate the at least one photovoltaic module about the axial direction of the support device. Alternatively or additionally, the second attachment device is configured to rotate the at least one photovoltaic module about a different axis of rotation—in particular an axis of rotation that is perpendicular to the axial direction of the support device. Alternatively or additionally, the second attachment device is configured to tilt the at least one photovoltaic module relative to the support device.

In an embodiment, the charging station includes the first attachment device and the second attachment device. In particular, the support device is pivotably connected to the housing via the first attachment device, and the at least one photovoltaic module is pivotably connected to the support device via the second attachment device. Advantageously, this allows orienting and/or arranging the at least one photovoltaic module in any desired orientation relative to the housing.

In a further embodiment, the charging station includes a control module, whereby the control module is configured to drive the first actuator and/or the second actuator. In particular, the control module is configured to drive the first actuator and/or the second actuator, such that the at least one photovoltaic module—in particularly in the course of a day—is moved in accordance with a predetermined trajectory relative to the housing, in particular tracking a solar position.

A further development of the invention provides that the charging station is additionally provided with a solar position measurement device. The solar position measurement device is configured to determine the current solar position and to drive the first actuator of the first attachment device, such that the at least one photovoltaic module can be oriented in accordance with the determined solar position. Alternatively or additionally, the solar position measurement device is configured to determine the solar position and to drive the second actuator of the second attachment device, such that the at least one photovoltaic module can be oriented in accordance with the determined solar position.

In particular, the solar position measurement device includes a solar position sensor. In particular, the solar position sensor is configured to cyclically determine the solar position, in particular as a brightest point in the sky. In addition, the solar position measurement device includes a control module, whereby the control module is configured to drive the first actuator and/or the second actuator. In particular, the control module is configured, when used in conjunction with the solar position sensor, to drive the first actuator and/or the second actuator, such that the at least one photovoltaic module is oriented in accordance with the last determined brightest point in the sky—in particular towards the last determined brightest point in the sky. This advantageously increases the power generation of the at least one photovoltaic module.

A further development of the invention provides that the charging station includes a frame. Thereby, the at least one photovoltaic module is arranged in the frame. Furthermore, the charging station includes at least one attachment device—in particular the first attachment device and/or the second attachment device, and the frame is connected to the housing via the at least one attachment device. Advantageously, this allows quickly and easily removing the frame together with the at least one photovoltaic module from the housing. Additionally and advantageously, the frame, together with the at least one photovoltaic module, may be rotated relative to the housing.

In an embodiment, the frame has a recess, in which the at least one photovoltaic module is disposed. Alternatively or additionally, the frame encloses the at least one photovoltaic module along the width and the length of the at least one photovoltaic module, in particular completely circumferentially.

In particular, the second attachment device is centered on the frame. Alternatively or additionally, the second attachment device is disposed in a center of gravity of the frame with the at least one photovoltaic module arranged therein.

In particular, the frame is connected to the support device via the second attachment device.

A further development of the invention provides that the at least one photovoltaic module is embodied as a roof. Advantageously, the roof serves as weather protection for a user of the charging station and/or as a glare protection for the display device.

In particular, the housing is geodetically disposed underneath the roof.

A further development of the invention provides that the roof extends at least partially over a motor vehicle parking space associated with the charging station. Advantageously, the roof serves as weather protection for a motor vehicle to be charged, which is parked in the motor vehicle parking space.

In particular, the at least one photovoltaic module—in particular the roof—and the motor vehicle parking space associated with the charging station have a vertical distance of 220 cm to 350 cm, in particular of 230 cm to 300 cm. In particular, the vertical distance between the at least one photovoltaic module—in particular the roof—and the motor vehicle parking space associated with the charging station is chosen, such that a user of the charging station is able to walk underneath the at least one photovoltaic module—in particular the roof—in an upright manner, in particular without touching the at least one photovoltaic module—in particular the roof.

A further development of the invention provides that the roof has a slope of more than 0° to 40°, in particular 1° to 30°, in particular 5° to 20°. Advantageously, the slope of the roof prevents water—in particular rain water—and/or snow from building up and/or accumulating on the roof. Furthermore, the slope allows forcing and/or predetermining a run-off direction of rain water and/or snowmelt and/or a snow sliding direction from the roof.

A further development of the invention provides that the charging station includes an illumination device. The illumination device is arranged on the at least one photovoltaic module, such that light generated by the illumination device is emitted geodetically downwards. Advantageously, this allows illuminating an environment of the charging station, in particular a motor vehicle parking space associated with the charging station and thereby allows easy use of the charging station at any time of day.

A further development of the invention provides that the charging station includes six to 16 photovoltaic modules as the at least one photovoltaic module. In an embodiment, the six to 16 photovoltaic modules are arranged and held in the frame.

In an embodiment, the six to 16 photovoltaic modules are embodied as a roof. In particular, the roof thus has an area of 4.5 m² to 32 m². Advantageously, such a roof allows at least partially covering the motor vehicle parking space associated with the charging station—in particular with a motor vehicle parking space width of at least 2.5 m and a motor vehicle parking space length of at least 4.5 m. Preferably, such a roof allows completely covering two motor vehicle parking spaces associated with the charging station—in particular in form of a carport.

The following table lists the electrical power per year in kWh and the cost savings in € for a roof with six to 16 photovoltaic modules. Thereby it is assumed, as before, that a photovoltaic module generates at least 300 Wₚ of power and the cost of electrical power from the public power grid is €0.30 per kWh.

| | | | Cost savings |
|---|---|---|---|
| | | Cost savings | per year- |
| Number of | | per year-grid | stand-alone |
| photovoltaic | Electrical power | charging | charging |
| modules | per year | station | station |
| 6 | 1200 kWh to 1800 kWh | €360 to €540 | €2400 |
| 7 | 1400 kWh to 2100 kWh | €420 to €630 | €2800 |
| 8 | 1600 kWh to 2400 kWh | €480 to €720 | €3200 |
| 9 | 1800 kWh to 2700 kWh | €540 to €810 | €3600 |
| 10 | 2000 kWh to 3000 kWh | €600 to €900 | €4000 |
| 11 | 2200 kWh to 3300 kWh | €660 to €990 | €4400 |
| 12 | 2400 kWh to 3600 kWh | €720 to €1080 | €4800 |
| 13 | 2600 kWh to 3900 kWh | €780 to €1170 | €5200 |
| 14 | 2800 kWh to 4200 kWh | €840 to €1260 | €5600 |
| 15 | 3000 kWh to 4500 kWh | €900 to €1350 | €6000 |
| 16 | 3200 kWh to 4800 kWh | €960 to €1440 | €6400 |

In particular, the cost for a charging station according to the invention or a charging station according to one or more of the previously described embodiments—in particular with six photovoltaic modules—is about €3000 higher than for a conventional charging station. Therefore, the additional cost of €3000 for a stand-alone charging station could amortize within about 1.25 years.

In the following, the invention is explained in more detail by means of the drawings. Therein:

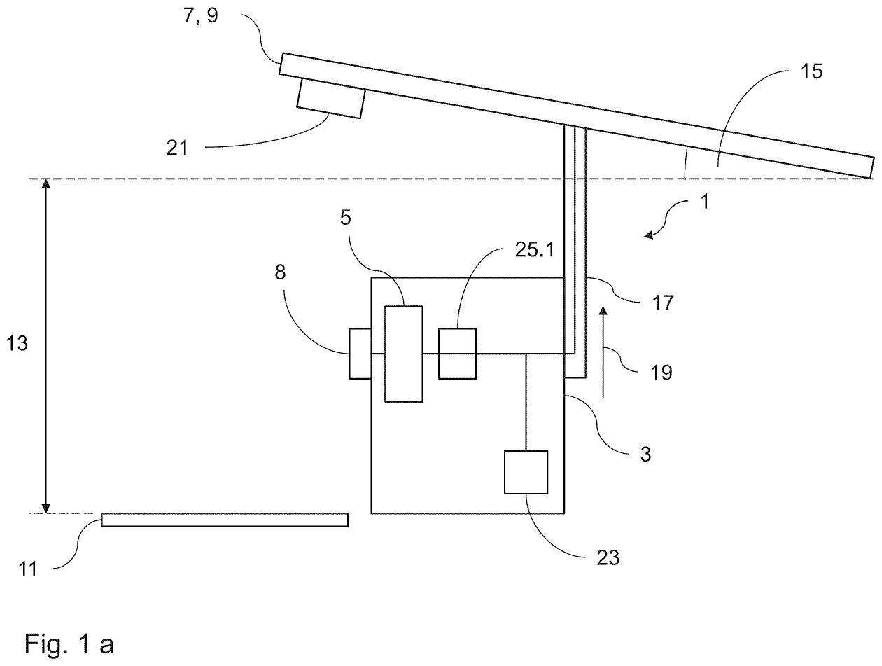

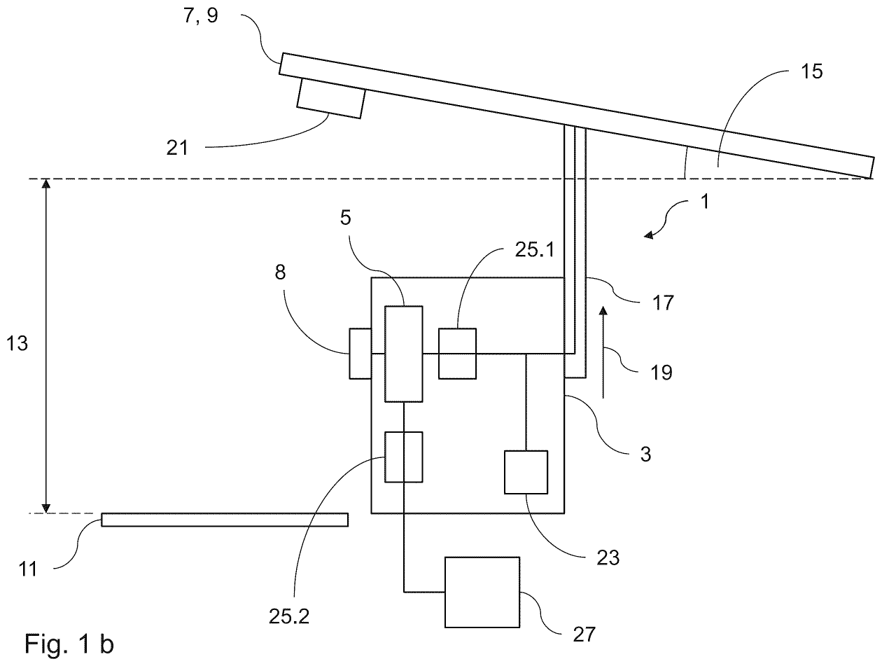

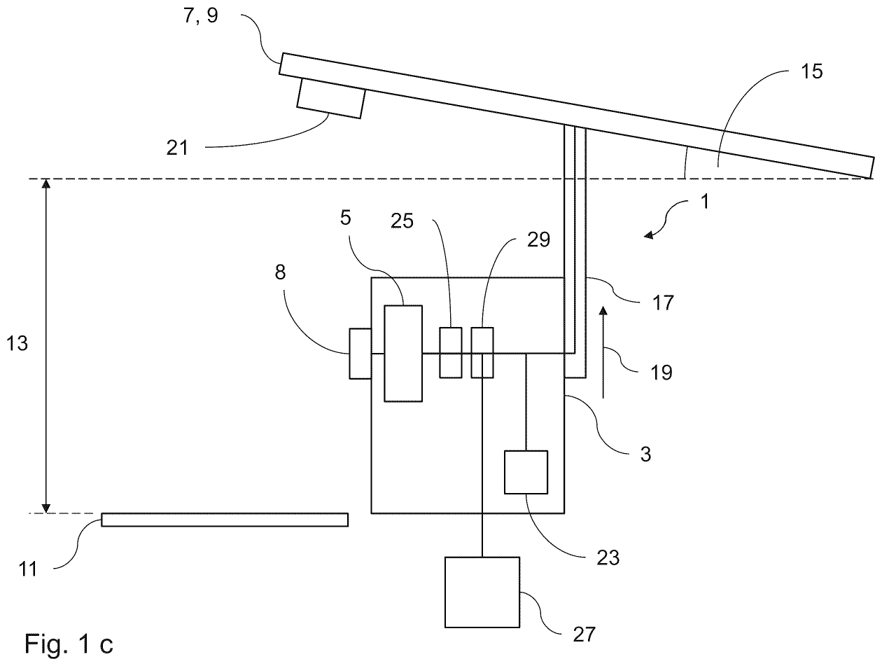

FIGS. 1a-1c schematically illustrate first, second, and third example embodiments of a charging station,

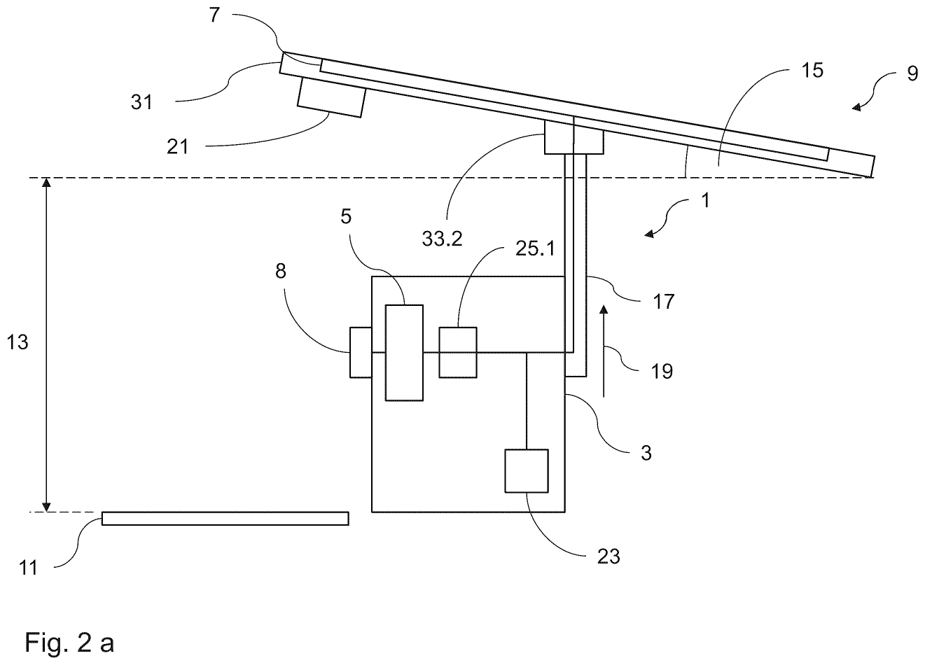

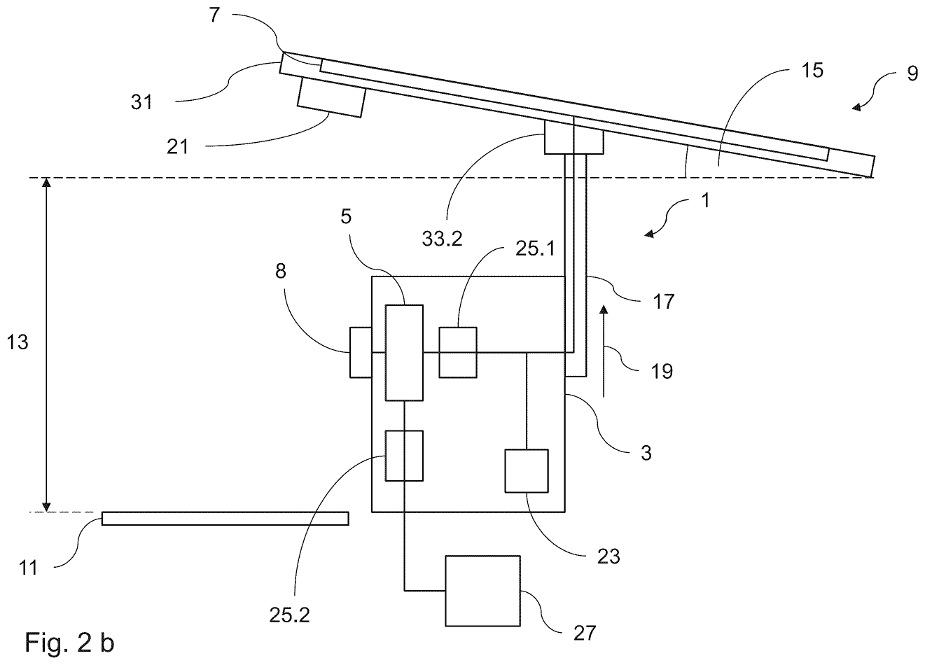

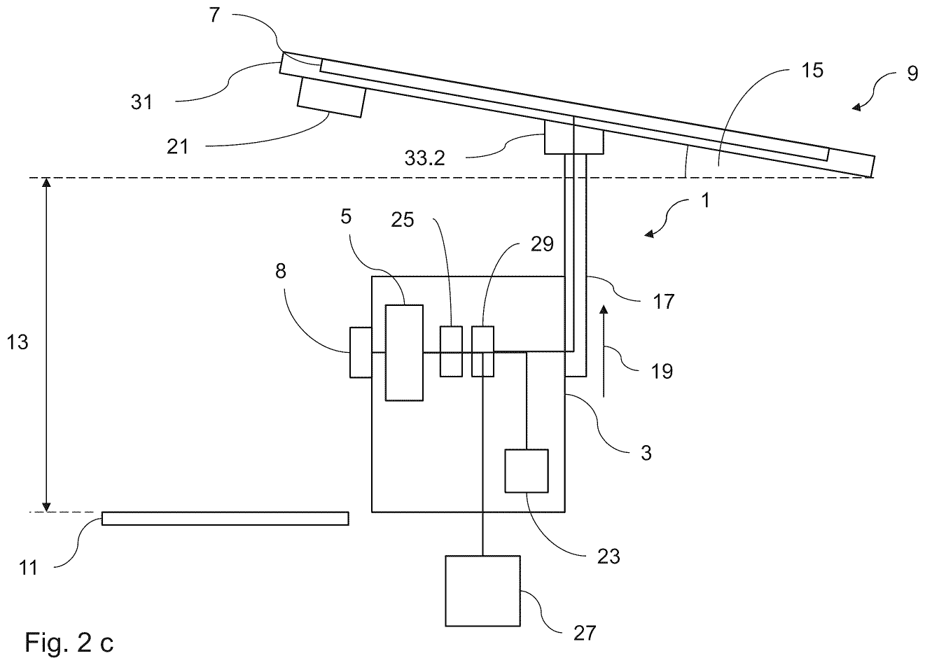

FIGS. 2a-2c schematically illustrate fourth, fifth, and sixth example embodiments of the charging station, and

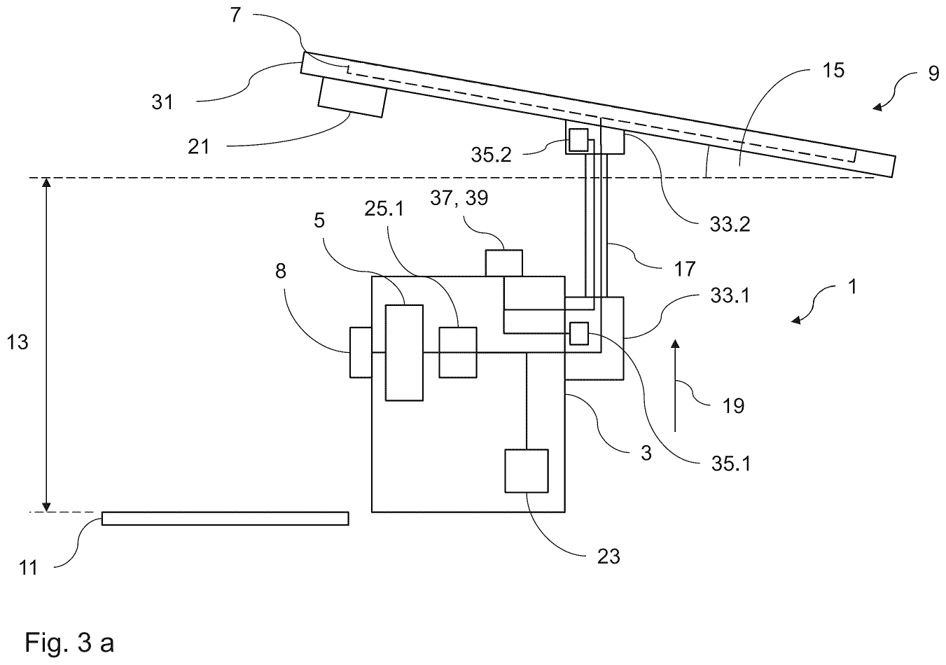

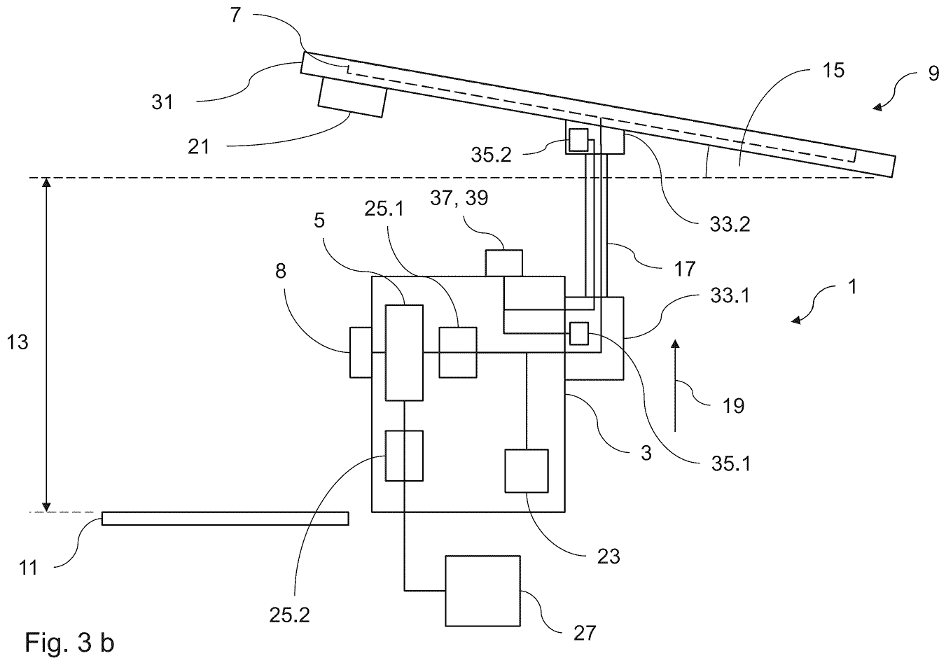

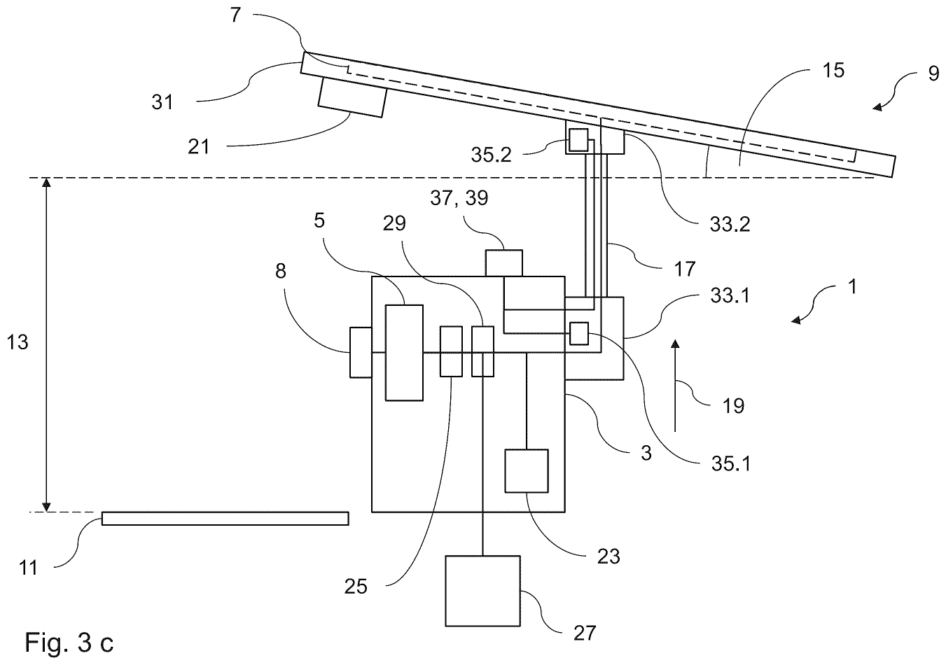

FIGS. 3a-3c schematically illustrate seventh, eighth, and ninth example embodiments of the charging station.

FIGS. 1a-1c schematically illustrate first, second, and third example embodiments of a charging station 1, including a housing 3, an electrical energy store 5, and at least one photovoltaic module 7.

The at least one photovoltaic module 7 is mechanically connected to the housing 3. In addition, the at least one photovoltaic module 7 is electrically connected to the electrical energy store 5, such that the electrical energy store 5 may be charged with electrical power generated by the at least one photovoltaic module 7.

In particular, the charging station 1 also includes at least one charging point 8. The at least one charging point 8 is electrically connected to the electrical energy store 5, in particular where direct current is directed from the electrical energy store 5 to the at least one charging point 8 for charging an electrical vehicle.

In particular, the at least one photovoltaic module 7 is configured as a roof 9. In particular, the housing 3 is hereby geodetically disposed underneath the roof 9. Alternatively or additionally, the roof 9 extends at least partially over a motor vehicle parking space 11 associated with the charging station 1.

In particular, the at least one photovoltaic module 7—in particular the roof 9—and the motor vehicle parking space 11 associated with the charging station have a vertical distance 13 of 220 cm to 350 cm, in particular of 230 cm to 300 cm. Alternatively or additionally, the at least one photovoltaic module 7—in particular the roof 9—has a slope angle 15 of more than 0° to 40°, in particular 1° to 30°, in particular 5° to 20°.

In a preferred embodiment, the charging station 1 includes six to 16 photovoltaic modules 7 as the at least one photovoltaic module 7. In particular, the roof 9 includes six to 16 photovoltaic modules 7.

In a further preferred embodiment the at least one photovoltaic module 7—in particular the roof 9—is connected to the housing 3 by means of a support device 17. In particular, with installation of the charging station 1 as intended, the support device 17 is connected to the housing 3 in a substantially vertical, in particular vertical manner. In particular, an axial direction 19 of the support device 17 is oriented in a vertical manner.

In particular, the support device 17 is embodied as a tube, in particular as a steel tube. Alternatively or additionally, the support device 17 includes a fiber composite or is composed of a fiber composite.

Optionally, the charging station 1 includes an illumination device 21. The illumination device 21 is arranged on the at least one photovoltaic module 7—in particular the roof 9—such that light generated by the illumination device 21 is emitted geodetically downwards. In particular, the illumination device 21 illuminates the housing 3 and/or the motor vehicle parking space 11 associated with the charging station 1.

Optionally, the charging station 1 includes at least one operating device 23, selected from a group consisting of a display device, an air conditioning device, a control device, and any combination of at least two of the aforementioned operating devices. The at least one operating device 23 is electrically connected to the at least one photovoltaic module 7, such that the at least one operation device 23 may be operated directly with the electrical power generated by the at least one photovoltaic module 7. In addition and in particular, the at least one operating device 23 is electrically connected to the electrical energy store 5.

FIG. 1a schematically illustrates the first example embodiment of the charging station 1. The charging station 1 is self-contained and is operated without electrical connection to a power grid.

In an embodiment, the at least one photovoltaic module 7 generates the electrical power as direct current and is electrically connected to the electrical energy store 5 in a direct fashion.

In an alternative embodiment, the at least one photovoltaic module 7 generates the electrical power as alternating current. Therefore, the charging station 1 includes a first rectifier 25.1 to convert an alternating current of the at least one photovoltaic module 7 into a direct current for charging the electrical energy store 5.

FIG. 1b schematically illustrates the second example embodiment of the charging station 1. The charging station 1 is electrically connected to a power grid 27. Therefore, the charging station 1 includes a second rectifier 25.2 to convert an alternating current of the power grid 27 into a direct current for charging the electrical energy store 5.

In particular, the at least one photovoltaic module 7 generates the electrical power as direct current and is electrically connected to the electrical energy store 5 in a direct fashion. Alternatively, the at least one photovoltaic module 7 generates the electrical power as alternating current. In this case, the charging station 1—analogously to FIG. 1a—includes the first rectifier 25.1 to convert an alternating current of the at least one photovoltaic module 7 into a direct current for charging the electrical energy store 5.

FIG. 1c schematically illustrates the second example embodiment of the charging station 1. The charging station 1 is electrically connected to the power grid 27, and the at least one photovoltaic module 7 generates the electrical power as alternating current.

In addition, the charging station 1 includes a regulating module 29. The regulating module 29 is electrically arranged between the at least one photovoltaic module 7 and the electrical energy store 5. Further, the regulating module 29 is configured to supply the electrical power generated by the at least one photovoltaic module 7 exclusively to the electrical energy store 5. Additionally, the power grid 27 and the at least one photovoltaic module 7 are electrically connected to the regulating module 29. In particular, the regulating module 29 is additionally configured to block supply of the electrical power generated by the at least one photovoltaic module 7 to the power grid 27, such that the charging station 1 generates electrical power exclusively for its own consumption and no supply to the power grid 27 occurs.

Furthermore, the charging station 1 includes a rectifier 25 to convert an alternating current of the at least one photovoltaic module 7 and of the power grid 27 into a direct current for charging the electrical energy store 5.

FIGS. 2a-2c schematically illustrate fourth, fifth, and sixth example embodiments of the charging station 1. In particular, the exemplary embodiments of FIG. 2 differ from the exemplary embodiments of FIG. 1 in the arrangement of the at least one photovoltaic module 7 on the housing 3.

In all figures, identical and functionally identical elements are provided with the same reference numerals, such that reference is made to the corresponding preceding description.

The charging station 1 includes a frame 31, whereby the at least one photovoltaic module 7 is arranged in the frame 31. Furthermore, the charging station 1—alternatively or additionally to a first attachment device 33.1 illustrated in FIG. 3—includes a second attachment device 33.2, and the frame 31 is connected to the housing 3 via the second attachment device 33.2. In particular, the frame 31 is connected to the support device 17 via the second attachment device 33.2.

In particular, the second attachment device 33.2 is configured as a quick-fit fastener. Alternatively or additionally, the second attachment device 33.2 is centered on the frame 31. Alternatively or additionally, the second attachment device 33.2 is disposed in a center of gravity of the frame 31 with the at least one photovoltaic module 7 arranged therein.

Particularly preferably, the frame 31 and the at least one photovoltaic module 7 arranged therein are embodied as the roof 9.

FIG. 2a schematically illustrates the fourth example embodiment of the charging station 1. The charging station 1 is self-contained and is operated without electrical connection to a power grid.

The fourth example embodiment of the charging station 1 is analogous to the first example embodiment of the charging station 1 of FIG. 1a, with the exception of the frame 31 and the second attachment device 33.2. In this respect, reference is made to the description of FIG. 1a.

FIG. 2b schematically illustrates the fifth example embodiment of the charging station 1. The charging station 1 is electrically connected to the power grid 27.

The fifth example embodiment of the charging station 1 is analogous to the second example embodiment of the charging station 1 of FIG. 1b, with the exception of the frame 31 and the second attachment device 33.2. In this respect, reference is made to the description of FIG. 1b.

FIG. 2c schematically illustrates the sixth example embodiment of the charging station 1. The charging station 1 is electrically connected to the power grid 27, and the at least one photovoltaic module 7 generates the electrical power as alternating current.

The sixth example embodiment of the charging station 1 is analogous to the third example embodiment of the charging station 1 of FIG. 1c, with the exception of the frame 31 and the second attachment device 33.2. In this respect, reference is made to the description of FIG. 1c.

FIGS. 3a-3c schematically illustrate seventh, eighth, and ninth example embodiments of the charging station 1. In particular, the exemplary embodiments of FIG. 3 differ from the exemplary embodiments of FIG. 1 and FIG. 2 in the arrangement of the at least one photovoltaic module 7 on the housing 3.

The support device 17 is—in particular pivotably—connected to the housing 3 via a first attachment device 33.1. In particular, the first attachment device 33.1 is configured as a quick-fit fastener.

In particular, the first attachment device 33.1 has a first pivot joint. Alternatively or additionally, the first attachment device 33.1 includes a first actuator 35.1. The first actuator 35.1 is specifically configured to rotate the support device 17 relative to the housing 3. In particular, the first actuator 35.1 is controllable via wire or wirelessly, such that an operator of the charging station 1 is able to easily initiate a rotation of the support device 17 relative to the housing 3. In particular, the first attachment device 33.1 is configured to rotate the support device 17 about the axial direction 19 of the support device 17.

The roof 9—in particular the at least one photovoltaic module 7 or the frame 31 with the at least one photovoltaic module 7 arranged therein—is—in particular pivotably—connected to the support device 17 via the second attachment device 33.2.

In particular, the second attachment device 33.2 has a second pivot joint. Alternatively or additionally, the second attachment device 33.2 includes a second actuator 35.2. The second actuator 35.2 is specifically configured to rotate the at least one photovoltaic module 7 relative to the support device 17. In particular, the second actuator 35.2 is controllable via wire or wirelessly, such that the operator of the charging station 1 is able to easily initiate a rotation of the at least one photovoltaic module 7 relative to the support device 17. In particular, the second attachment device 33.2 is configured to rotate the at least one photovoltaic module 7 about the axial direction 19 of the support device 17. Alternatively or additionally, the second attachment device 33.2 is configured to rotate the at least one photovoltaic module 7 about an arbitrary axis of rotation. Alternatively or additionally, the second attachment device 33.2 is configured to tilt the at least one photovoltaic module 7 relative to the support device 17 and thereby, in particular, change the slope angle 15.

In an embodiment, the charging station 1 includes a control module 37. The control module 37 is configured to drive the first actuator 35.1 and/or the second actuator 35.2. In particular, the control module 37 is configured to drive the first actuator 35.1 and/or the second actuator 35.2, such that the at least one photovoltaic module 7—in particularly in the course of a day—is moved in accordance with a predetermined trajectory relative to the housing 3, in particular tracking a solar position.

In an alternative embodiment, the charging station 1 includes a solar position measurement device 39. The solar position measurement device 39 is configured to determine the solar position and to drive the first actuator 35.1 of the first attachment device 33.1, such that the at least one photovoltaic module 7 can be oriented in accordance with the determined solar position. Alternatively or additionally, the solar position measurement device 39 is configured to determine the solar position and to drive the second actuator 35.2 of the second attachment device 33.2, such that the at least one photovoltaic module 7 can be oriented in accordance with the determined solar position.

FIG. 3a schematically illustrates the seventh example embodiment of the charging station 1. The charging station 1 is self-contained and is operated without electrical connection to a power grid.

The seventh example embodiment of the charging station 1 is analogous to the first example embodiment of the charging station 1 of FIG. 1a and the fourth example embodiment of the charging station 1 of FIG. 2a, with the exception of the arrangement of the at least one photovoltaic module 7. In this respect, reference is made to the description of FIGS. 1a and 2a.

FIG. 3b schematically illustrates the eighth example embodiment of the charging station 1. The charging station 1 is electrically connected to the power grid 27.

The eighth example embodiment of the charging station 1 is analogous to the second example embodiment of the charging station 1 of FIG. 1b and the fifth example embodiment of the charging station 1 of FIG. 2b, with the exception of the arrangement of the at least one photovoltaic module 7. In this respect, reference is made to the description of FIGS. 1b and 2b.

FIG. 3c schematically illustrates the sixth example embodiment of the charging station 1. The charging station 1 is electrically connected to the power grid 27, and the at least one photovoltaic module 7 generates the electrical power as alternating current.

The ninth example embodiment of the charging station 1 is analogous to the third example embodiment of the charging station 1 of FIG. 1c and the sixth example embodiment of the charging station 1 of FIG. 2c, with the exception of the arrangement of the at least one photovoltaic module 7. In this respect, reference is made to the description of FIGS. 1c and 2c.

1. A charging station comprising a housing, an electrical energy store, and at least one photovoltaic module, wherein
the at least one photovoltaic module is mechanically connected to the housing, and wherein
the at least one photovoltaic module is electrically connected to the electrical energy store, such that the electrical energy store may be charged with electrical power generated by the at least one photovoltaic module.

2. The charging station according to claim 1, comprising a regulating module (29), wherein the regulating module (29) is arranged electrically between the at least one photovoltaic module and the electrical energy store, and wherein the regulating module (29) is configured to supply the electrical power generated by the at least one photovoltaic module exclusively to the electrical energy store.

3. The charging station according to claim 1, wherein the at least one photovoltaic module is connected to the housing by means of a support device.

4. The charging station according to claim 3, wherein the support device is pivotably connected to the housing via a first attachment device.

5. The charging station according to claim 3, wherein the at least one photovoltaic module is pivotably connected to the support device via a second attachment device.

6. The charging station according to claim 4, comprising a solar position measurement device configured to determine a solar position and to drive at least a first actuator of the first attachment device and/or a second actuator of the second attachment device, such that the at least one photovoltaic module may be oriented in accordance with the determined solar position.

7. The charging station according to claim 1, comprising a frame, wherein
the at least one photovoltaic module is arranged in the frame, wherein
the frame (31) is connected to the housing via at least one attachment device.

8. The charging station according to claim 1, wherein the at least one photovoltaic module is embodied as a roof, and in particular wherein the housing is geodetically disposed underneath the roof.

9. The charging station according to claim 8, wherein the roof extends at least partially over a motor vehicle parking space associated with the charging station.

10. The charging station according to claim 8, wherein the roof has a slope of more than 0° to 40°.

11. The charging station according to claim 1, comprising an illumination device, wherein the illumination device is arranged on the at least one photovoltaic module, such that light generated by the illumination device is emitted geodetically downwards.

12. The charging station according to claim 1, comprising six to 16 photovoltaic modules as the at least one photovoltaic module.
